(19) United States
(12) Patent Application Publication
(10) Pub. No.: US 2010/0305861 A1
(43) Pub. Date: Dec. 2, 2010

(54) SYSTEMS AND METHODS TO PROCESS OILFIELD DATA

(75) Inventors: MASAMI HATTORI, TOKYO (JP); TAKASHI MIZUNO, YOKOHAMA-SHI (JP)

Correspondence Address: SCHLUMBERGER K.K., 2-2-1 FUCHINOBE, CHUO-KU, SAGAMIHARA-SHI, KANAGAWA-KEN, 252-0206, JP

(73) Assignee: SCHLUMBERGER TECHNOLOGY CORPORATION, Sugar Land, TX (US)

(21) Appl. No.: 12/786,439

(22) Filed: May 25, 2010

Related U.S. Application Data
(60) Provisional application No. 61/181,670, filed on May 28, 2009.

(51) Int. Cl. G06F 19/00; G01V 1/40

(52) U.S. Cl. 702/6; 702/14

(57) ABSTRACT

Systems and methods to process oilfield data are disclosed. An example system for processing oilfield data includes a first computer comprising a first processor and first memory and a second computer coupled to the first computer, the second computer having a second processor and a second memory. The example second processor has a faster processing speed than the first processor and the first memory stores an amount of oilfield data larger than the second memory and instructions for: receiving the oilfield data at the first computer, processing the oilfield data at the first computer to generate second data, transmitting at least a portion of the second data to the second computer for processing performed by the second computer, wherein the processing performed by the second computer has a higher computational load than the processing performed by the first computer, and receiving data resulting from the processing by the second computer.

### RELATED APPLICATIONS

This application claims priority from U.S. Provisional Application No. 61/181,670, filed May 28, 2009, the entirety of which is incorporated herein by reference.

### FIELD OF THE DISCLOSURE

This disclosure relates generally to data processing and, more particularly, to methods and apparatus to process oilfield data.

### BACKGROUND

The Cell Broadband Engine™ processor (Cell), which is used in Sony PS3, is a general purpose processor with high computing performance. The theoretical peak performance of Cell is over 200 gigaflops (GFlops), while the theoretical peak performance of a 3.0 gigahertz (GHz) dual-core Pentium® is 25 GFlops. As an effective performance, Cell has reportedly shown over 170 GFlops performance for Cholesky Factorization. While the high performance of Cell is known, the PS3 is not widely used for high performance computing, in part because the PS3 has only 256 megabytes (MB) of memory and performance drastically degrades if page swapping occurs.

### SUMMARY

Systems and methods to process oilfield data are described herein. An example method to process oilfield data includes receiving oilfield data at a first computer having a first processor, processing the oilfield data to generate second data representative of the oilfield data, wherein a first portion of the processing is performed by the first computer and a second portion of the processing is performed by a second computer having a higher processing speed and a smaller memory than the first computer, and wherein the first and second portions have different computational loads, and transmitting data resulting from the second portion of the processing from the second computer to the first computer.

An example system to process oilfield data is also described, which includes a first computer comprising a first processor and first memory and a second computer coupled to the first computer, the second computer having a second processor and a second memory. The example second processor has a faster processing speed than the first processor and the first memory stores oilfield data larger than the second memory. The first memory also stores instructions for receiving the oilfield data at the first computer, processing the oilfield data at the first computer to generate second data, transmitting at least a portion of the second data to the second computer for processing performed by the second computer, wherein the processing performed by the second computer has a higher computational load than the processing performed by the first computer, and receiving data resulting from the processing by the second computer.

### BRIEF DESCRIPTION OF THE DRAWINGS

FIG. 1 is an example hybrid computation system including a general purpose computer and a Cell-based processing platform.

FIG. 2 is a block diagram of the architecture of a Cell processor.

FIG. 3 is a more detailed block diagram of the example system of FIG. 1.

FIG. 4 illustrates an example cross-correlation coefficient calculation.

FIG. 5 is a flowchart illustrating an example method that may be implemented to identify microseismic multiplets.

FIG. 6 is a flowchart illustrating an example method that may be used to determine a cross-correlation coefficient between a new event and a master event.

FIG. 7 is a flowchart illustrating another example method that may be used to determine a cross-correlation coefficient between a new event and a master event.

FIG. 8 depicts an example parallelization of trace cross-correlation function calculations to a plurality of Synergistic Processing Elements in the Cell processor of FIG. 2.

FIG. 9 depicts an example operation using a single-instruction-multiple-data instruction and a corresponding scalar instruction.

FIG. 10A is an example pseudocode listing including single-instruction-multiple-data instructions to perform a cross-correlation function determination.

FIG. 10B is an example pseudocode listing including scalar instructions to perform the cross-correlation function determination of FIG. 10A.

FIG. 11 illustrates example cross-correlation coefficients from a real-time multiplet identification operation with a microseismic dataset for hydraulic fracturing.

FIG. 12 illustrates an example comparison of master waveforms and slave waveforms between the event pairs comprising a doublet.

FIG. 13 is a graph illustrating the execution times of a known real-time multiplet identification program run on a general purpose computer using Windows® and the execution times of the example real-time multiplet identification system of FIG. 1 and the example methods of FIGS. 5 and 6.

FIG. 14 is a graph illustrating the execution times of a known real-time multiplet identification program run on a general purpose computer using Windows® and the execution times of the example real-time multiplet identification system of FIG. 3 and the example methods of FIGS. 5 and 7.

FIG. 15 illustrates an example oilfield data processing system that includes a general purpose computer and two Playstation 3s.

FIG. 16 illustrates another example oilfield data processing system that includes a general purpose computer and two Playstation 3s.

FIG. 17 is a block diagram of an example computing system that may be used to implement the example systems and methods described herein.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness. Although the following discloses example systems including, among other components, software or firmware executed on hardware, it should be noted that such systems are merely illustrative and should not be considered as limiting. Accordingly, while the following describes example systems, persons of ordinary skill in the art will readily appreciate that the examples are not the only way to implement such systems.

The example methods and apparatus described herein may be used to process oilfield data, such as seismic activity data, in real time using a high performance computing platform. Some example methods and apparatus described herein use a Cell Broadband Engine™ processor-based platform, such as the Sony PLAYSTATION® 3 (PS3®), in combination with a general purpose computer to process seismic activity data. In particular, some example methods and apparatus process micro-seismic events to determine groups of closely-related events.

Reservoir seismicity sometimes shows swarm-like activity, showing mutual similarity for waveforms between events. As used herein, an event refers to a microseismic event (e.g., a micro-earthquake) that may be detected by, for example, seismometers or other seismic activity sensors. A doublet refers to a pair of similar events (e.g., two events having a cross-correlation greater than a lower threshold), and a multiplet is a group of at least three events for which each event in the multiplet is a doublet of at least one other event in the multiplet. These events are considered as events occurring close to each other and having a similar source mechanism. Each group is described by a master (parent) event and one or more slave (child) events. A master event is the representative waveform signature for the corresponding event group (family), which may be a doublet or a multiplet. In some examples, the master event is established as the event in a group that has the lowest signal-to-noise ratio in data representative of the event. However, the master event may be established using other characteristics of the events.

Real-time multiplets identification (RTMI) indicates out-of-zone growth of subterranean formation fractures because multiplets can be observed when out-of-zone growth of a fracture occurs. Using multiplet relocation techniques such as the double-difference method described by Waldhauser and Ellsworth in “A Double-Difference Earthquake Location Algorithm: Method and Application to the Northern Hayward Fault, California,” Bulletin of the Seismological Society of America, Vol. 90, No. 6, pp. 1353-1368, December 2000, better images of fracture networks can be inferred than by using conventional event-by-event location processing. Accordingly, multiplets of microseismic events must be determined to use these methods.

In contrast to known real-time seismic activity processing systems, the example systems and methods described below may process and correlate a larger number of data points in real time, which greatly increases the value of the measurements for evaluating subterranean formations. In contrast to known high performance computing platforms, the example systems and methods described herein are scalable and may have a lower cost to implement. For example, known RTMI processing programs that run on a general purpose computer process new events more slowly as the number of events increases. In particular, when 300 events have been detected, the processing time for each new event takes longer than the intervals at which new events are received when the rate of events is one event about every 3 seconds.

While the high performance of Cell is known, the PS3 is not widely used for high performance computing, in part because the PS3 has only 256 megabytes (MB) of memory and performance substantially degrades if page swapping occurs. In contrast to the known RTMI programs or systems, example systems and methods described herein can process up to 2,100 events in real-time, when the time between events is about 3 seconds, using a general purpose computer and a Cell-based processing platform such as the PS3. Further, the example systems and methods described herein may be scaled to process up to 5,000 master events or more using two or more off-the-shelf Cell-based PS3s. Additionally, the example systems and methods described herein may be further scaled as Cell-based processing platforms increase in processing speed and memory.

More generally, the example systems and methods described herein may be used to process of oilfield data. In some examples, a first, general-purpose computer receives oilfield data and transmits the oilfield data and/or data generated from the oilfield data to a second computer. The second computer (e.g., a PS3) has a higher processing speed than the first computer but a smaller memory capacity. The first computer delegates at least some of the processing to the PS3, where the delegated portion of the processing may have a higher computational load than another portion of the processing performed by the first computer. While an example program and example data is described herein, the examples are not limited to such programs or types of data. To the contrary, the oilfield data may be representative of any type of data obtained from an oilfield, including but not limited to, drilling data, borehole evaluation data, and/or production data, and the program may be any type of processing program to process the data.

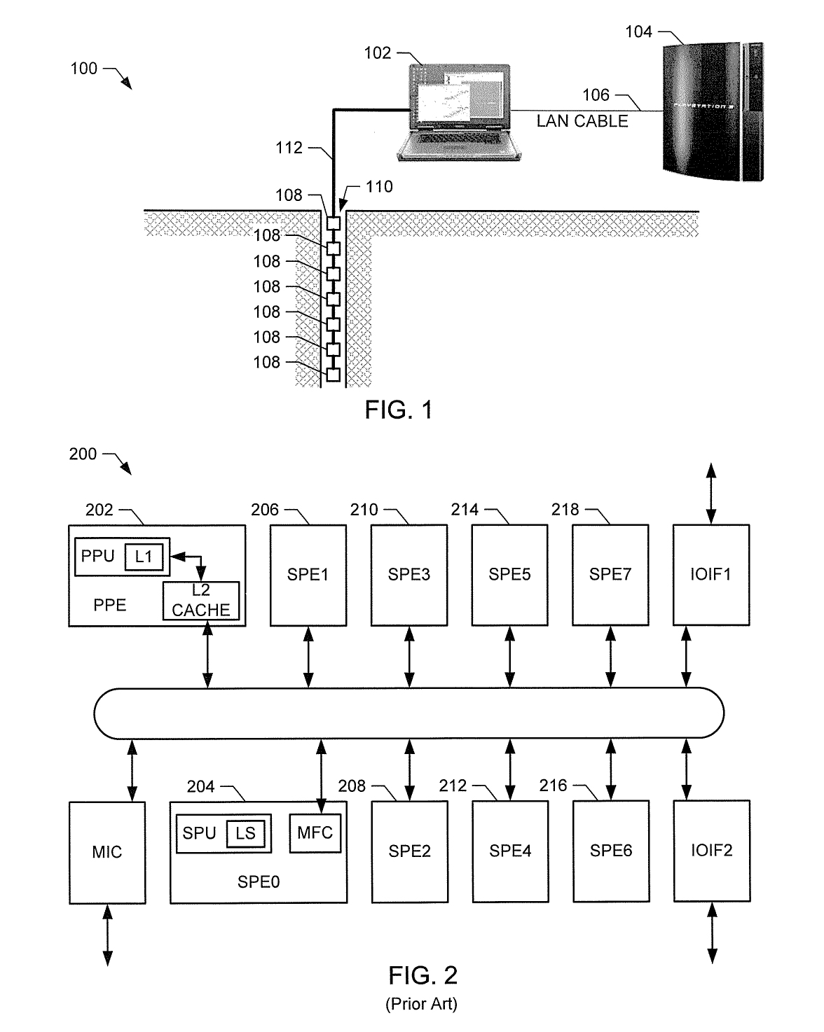

FIG. 1 is an example oilfield data processing (e.g., RTMI) system 100 including a general purpose computer 102 and a Cell-based processing platform 104. The example RTMI system 100 uses a PS3 to implement the Cell-based processing platform 104. The example system 100 of FIG. 1 may be used to leverage the PS3 for high performance computing for applications that require large amounts of memory, such as RTMI or other oilfield data processing applications. The example RTMI application described herein may use more memory (e.g., random access memory (RAM)) than the example Cell-based processing platform 104 provides. In the example system 100, the computer 102 and the Cell-based processing platform 104 are connected via a LAN cable 106 such as an Ethernet cable. In the example system 100, the application runs on the general purpose computer 102, which delegates computationally expensive procedures (e.g., procedures having high computational loads) to the Cell-based processing platform 104 via the LAN cable 106. For example, the general purpose computer 102 may delegate to the Cell-based processing platform 104 a portion of a process that consumes about 80% of the computation time of the process on a known Windows-based RTMI system. Of course, other computational loads may be delegated to the Cell-based processing platform 104 to improve total computation time in the RTMI system 100.

The example system 100 may be used to implement an RTMI process, which identifies multiplets of microseismic data (e.g., data representative of micro-earthquakes and/or other small-scale seismic activity) based on the similarity of waveform data that characterizes the microseismic data. As explained in more detail below, the RTMI process performs cross-correlation computations; which are computationally expensive. The cross-correlation computations are therefore configured to execute on the Cell-based processing platform 104, while the rest of the RTMI process, such as data input and output, may be executed on the computer 102.

To receive data or information representative of seismic activity, the computer 102 is placed in communication with one or more seismometers 108 that are positioned at horizontal intervals within a borehole 110. However, the seismometers 108 may additionally or alternatively be placed at other horizontal and/or vertical intervals within the borehole 110. The example seismometers 108 are connected or coupled to the computer 102 via a bus 112 or other communication line or medium. The seismometers 108 measure seismic activity and, thus, transmit data or information representative of the seismic activity (e.g., waveforms, data, signals, etc.) to the computer 102 for processing.

FIG. 2 is a block diagram of the architecture of the Cell processor 200 that may be used to implement the Cell-based processing platform 104 of FIG. 1. The Cell Broadband Engine processor 200 has one PowerPC Processor Element (PPE) 202, which is a general purpose processor core, and eight Synergistic Processor Elements (SPE0-SPE7) 204-218, which are processing cores. The PPE 202 is a PowerPC architecture-compliant 64-bit processor element that controls the SPEs 204-218. The SPEs 204-218 are vector processors that may be controlled using single-instruction-multiple-data (SIMD) instructions, which cause one or more of the SPEs 204-218 to process four floating-point operations with one instruction on all 128 general purpose registers. With two asymmetrical pipelines, an SPE 204 can issue two instructions at the same time. However, the SPEs 204-218 cannot directly access the main memory. Both program and data need to be transferred by Direct Memory Access (DMA) to a 256 KB size Local Store (LS) in each of the SPEs 204-218. The PPE 202 and the SPEs 204-218 do not have out-of-order execution or branch prediction mechanisms.

Based on the above processor characteristics, execution of RTMI or other oilfield data processing applications on the Cell processor 200 may be improved using any one or more of the following techniques: (1) run expensive computation on the SPEs 204-218 and control the SPEs 204-218 using the PPE 202; (2) use SIMD instructions as much as practical; (3) use as many registers as possible (e.g., via loop unrolling); (4) order instructions so that both of the two pipelines are filled (dual-issue). (5) hide DMA memory transfer latency with double buffering; and/or (6) avoid or reduce conditional branching. However, on the PS3, application programs may only use six out of the eight SPEs 204-218.

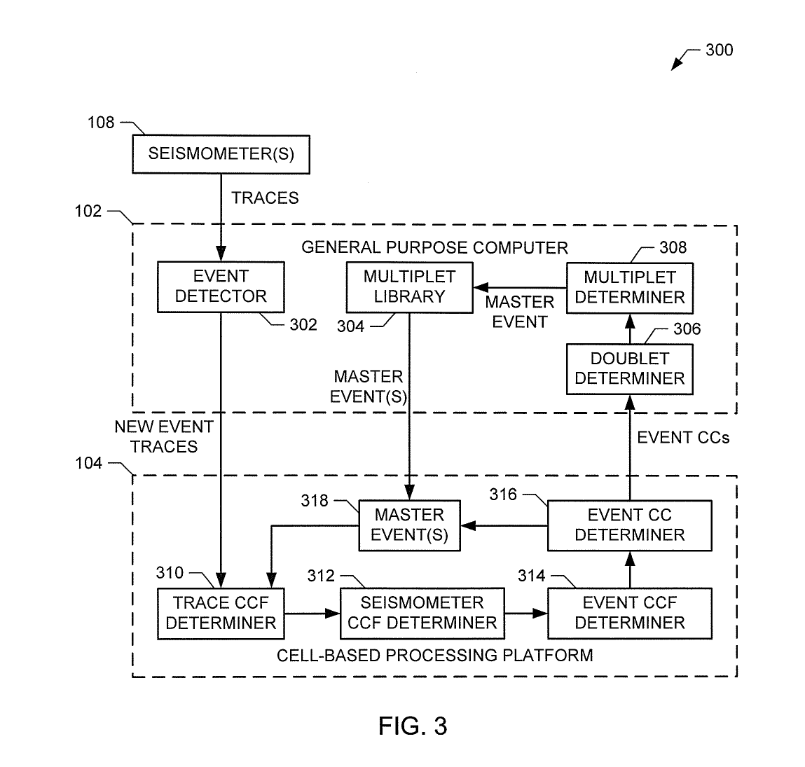

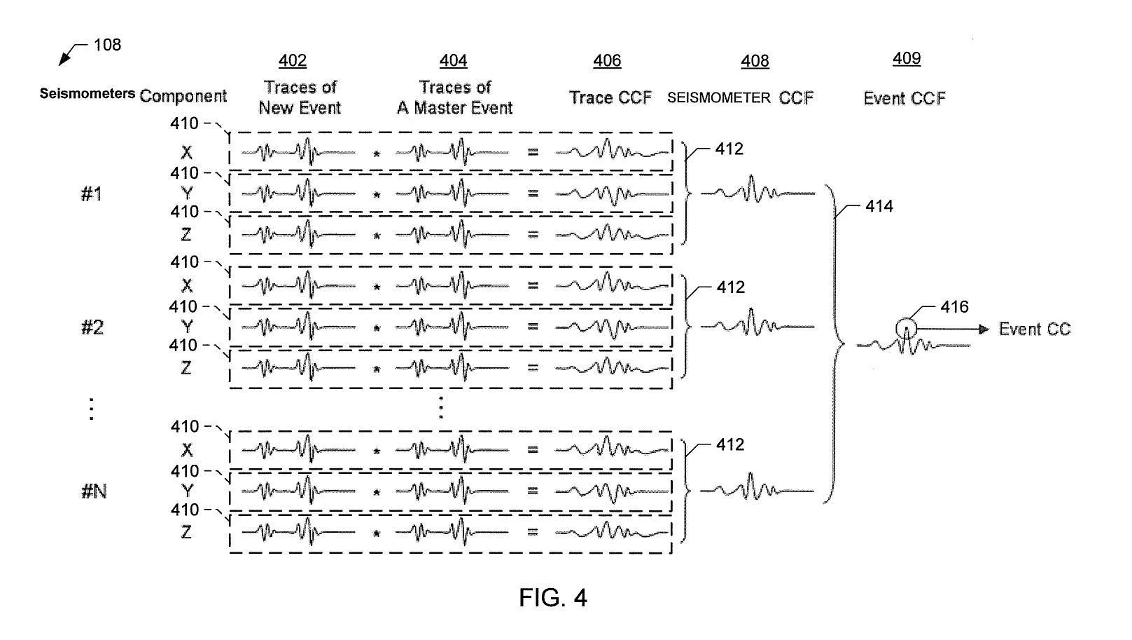

FIG. 3 is a more detailed block diagram of the example system 100 of FIG. 1. The example system 100 includes the general purpose computer 102 and the Cell-based processing platform 104 (e.g., a PS3). As illustrated in FIG. 3, the general purpose computer 102 is coupled to one or more of the seismometers 108 to receive seismic data for processing. The following description of the example system 100 of FIG. 3 will refer to an example determination of an event cross-correlation from seismic data as illustrated in FIG. 4.

The general purpose computer 102 includes an event detector 302, a multiplet library 304, a doublet determiner 306, and a multiplet determiner 308. The Cell-based processing platform 104 includes a trace cross-correlation function (CCF) determiner 310, a seismometer CCF determiner 312, an event CCF determiner 314, an event cross-correlation (CC) determiner 316, and a master event(s) list 318. As described in more detail below, any one or more of the trace CCF determiner 310, the seismometer CCF determiner 312, the event CCF determiner 314, and/or the event cross-correlation CC determiner 316 may be implemented using the Cell processor 200 of FIG. 2.

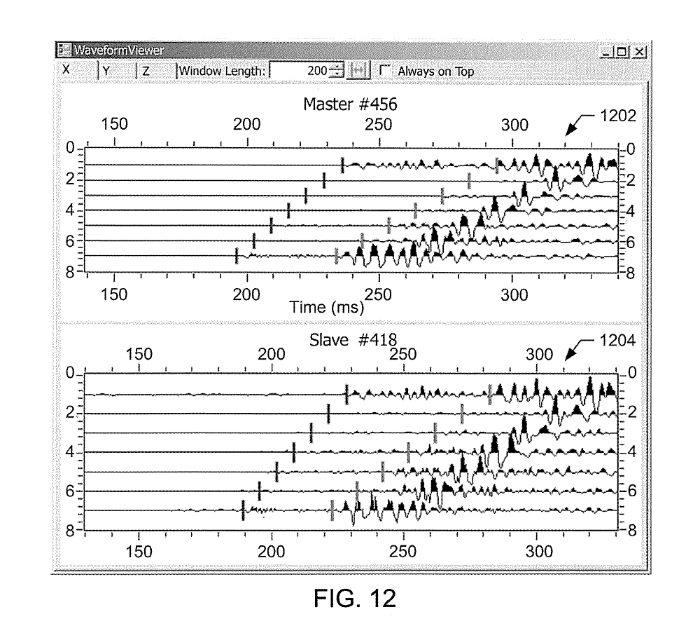

As mentioned above, the system 100 receives seismometer data, detects events from the data, and identifies multiplets from the detected events. Each group of events is represented by a master event. The event detector 302 receives a flow of data from each of the seismometer(s) 108 in the form of plots or traces in the X, Y, and Z directions with respect to time. FIGS. 4 and 12 show examples of such traces. The example seismometers 108 are represented in FIG. 4 by seismometers #1, #2, . . . #N, each having components X, Y, and Z. When the event detector 302 detects a new event, the event detector 302 transmits the traces 402 corresponding to the new event to the trace CCF determiner 310 in the Cell-based processing platform 104. In the illustrated example, the event detector 302 detects events using the method described in U.S. patent application Ser. No. 12/420,061, which is assigned to Schlumberger Technology Corporation of Sugar Land, Tex. and incorporated by reference herein in its entirety. In addition to receiving the new event traces 402, the trace CCF determiner 310 receives traces 404 of master events stored in the multiplet library 304. The master events are representative of previously-identified multiplets. Of course, the first new event detected by the event detector 302 does not have any master event traces 404 with which it can be correlated and, therefore, automatically becomes a master event. Subsequent new events detected by the event detector 302 may be grouped into a doublet and/or a multiplet or may become a new master event as described below.

For each master event received from the multiplet library 304, the example trace CCF determiner 310 determines a CCF for each component trace (e.g., an X component, a Y component, a Z component) between the new event component trace 402 and a corresponding master event component trace 404. Stated differently, the trace CCF determiner 310 determines a CCF for the X component traces of the new event and a master event, determines a CCF for the Y component traces of the new event and the master event, and determines a CCF for the Z component traces of the new event and the master event for each master event 404 in the multiplet library 304. As described by Arrowsmith and Eisner in “A Technique for Identifying Microseismic Multiplets and Application to the Valhall field, North Sea,” Geophysics, Vol. 71, No. 2 (March-April 2006), the CCF Cₓ(τᵢ) may be determined using Equation 1 below, where F_{D}⁻¹ denotes the inverse discrete Fourier transform, X₁*(f) is the complex conjugate of the Fourier transform of x₁(t), and X₂(f) is the Fourier transform of x₂(t). As illustrated in FIG. 4, the trace CCF determiner 310 performs the calculations designated 410 to generate corresponding trace CCFs 406. In some examples, the calculations 410 may be performed in parallel via two or more of the SPEs 204-218 of FIG. 2.

$${C}_{x} ( {τ}_{i} ) = \frac{{F}_{D}^{- 1} ( {X}_{1}^{*} ( f ) {X}_{2} ( f ) )}{\sqrt{\sum {x}_{1}^{2} ( t ) \sum {x}_{2}^{2} ( t )}} \qquad ( Eq . 1 )$$

The trace CCF determiner 310 provides the trace CCFs 406 to the seismometer CCF determiner 312. The seismometer CCF determiner 312 determines a seismometer CCF 408 for each of the seismometers 108 based on the trace CCFs 406 for the component traces of the respective seismometers 108. For example, the seismometer CCF determiner 312 may determine a seismometer CCF 408 for each seismometer 108 based on the signal weighted average of the trace CCFs 406 according to Equation 2, as described by Arrowsmith and Eisner. In Equation 2, Cₓ, C_{y}, C_{z} are the normalized CCFs for each component trace; Aₓ, A_{y}, A_{z} are the maximum amplitudes for each component trace; and τ₁ is the lag time of the cross-correlation for the ith seismometer 108. FIG. 4 illustrates the example calculations performed by the seismometer CCF determiner 312, which are designated 412.

$${C}_{i} ( {τ}_{i} ) = \frac{{A}_{x} {C}_{x} ( {τ}_{i} ) + {A}_{y} {C}_{y} ( {τ}_{i} ) + {A}_{z} {C}_{z} ( {τ}_{i} )}{{A}_{x} + {A}_{y} + {A}_{z}} \qquad ( Eq . 2 )$$

The seismometer CCF determiner 312 provides the seismometer CCFs 408 to the event CCF determiner 314, which determines an event CCF 409 between the new event and each master event based on the corresponding seismometer CCFs 408. The event CCF determiner 314 may, for example, determine the event CCF 409 according to Equations 3 and 4 using the seismometer CCFs 408. The determination of the event CCF 409 is illustrated in FIG. 4 using the designation 414.

$$\begin{matrix}C ( τ ) = \frac{1}{{\sum }_{i} {W}_{i}} {\sum }_{i} {W}_{i} {C}_{i} ( τ ) & ( Eq . 3 ) \\ {W}_{i} = {\sum }_{j} {A}_{ij} & ( Eq . 4 )\end{matrix}$$

The result of Equations 3 and 4 is an event CCF 409 between the new event and a master event in the multiplet library 304. The event CC determiner 316 determines the event CCs between the new event and each of the master events by determining the maximum value of the event CCF 409. However, values other than the maximum may be used depending on the application. The event CC for an example event CCF 409 is illustrated in FIG. 4 and is designated 416.

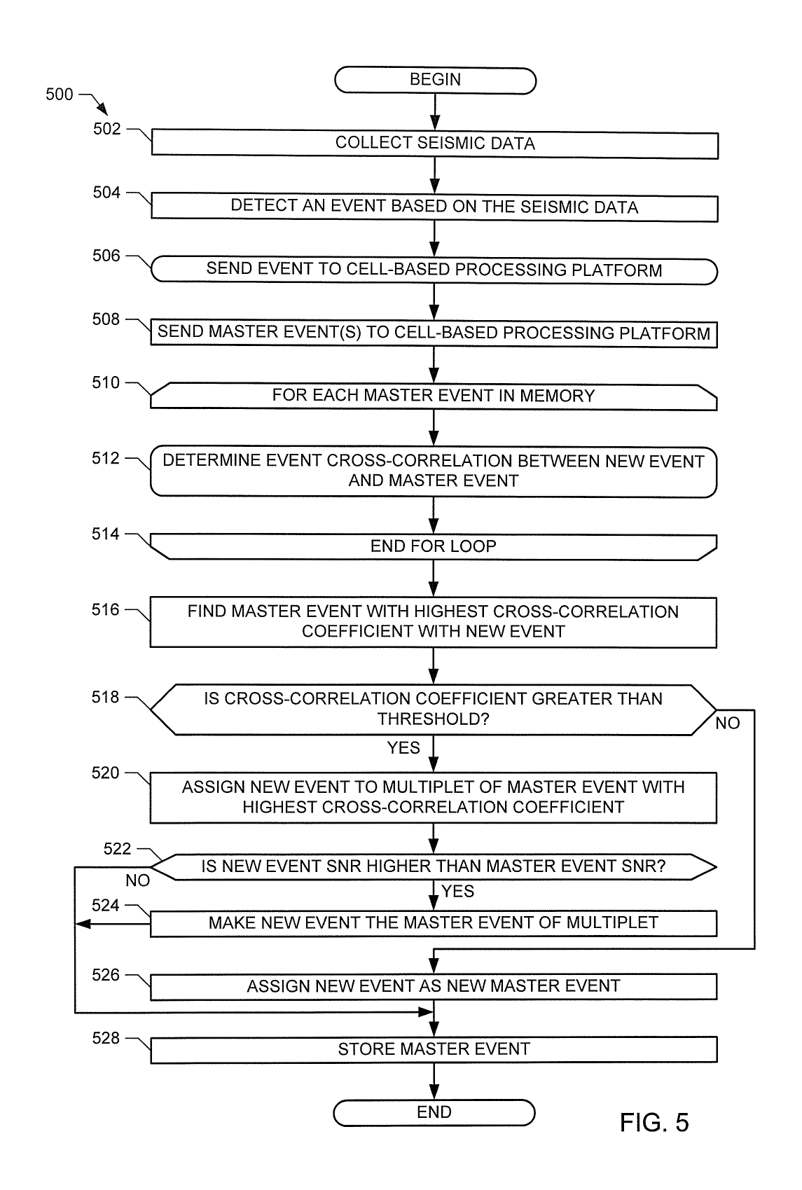

FIG. 5 is a flowchart illustrating an example method 500 that may be implemented to perform oilfield data processing. In particular, the example method 500 may be used to implement the example general purpose computer 102 and the example Cell-based processing platform 104 of FIGS. 1 and 3 to perform real-time multiplet identification for microseismic data.

The example method 500 begins by collecting seismic data (e.g., from the seismometers 108 of FIG. 1) (block 502). In the illustrated example, the seismometers 108 collect data traces of seismic activity having three components (e.g., X, Y, and Z). The general purpose computer 102 (e.g., via the event detector 302) monitors and/or analyzes the seismic data to detect an event (block 504). In some examples, the method 500 may automatically assign the detected event as a master event (thereby skipping the remaining blocks) for the first detected event and iterate the method 500 to detect another event. Upon detecting a second or subsequent event, the event detector 302 sends the event (e.g., the component traces corresponding to the event) to the Cell-based processing platform 104 (block 506). The general purpose computer 102 further transmits master events to the Cell-based processing platform 104 (block 508).

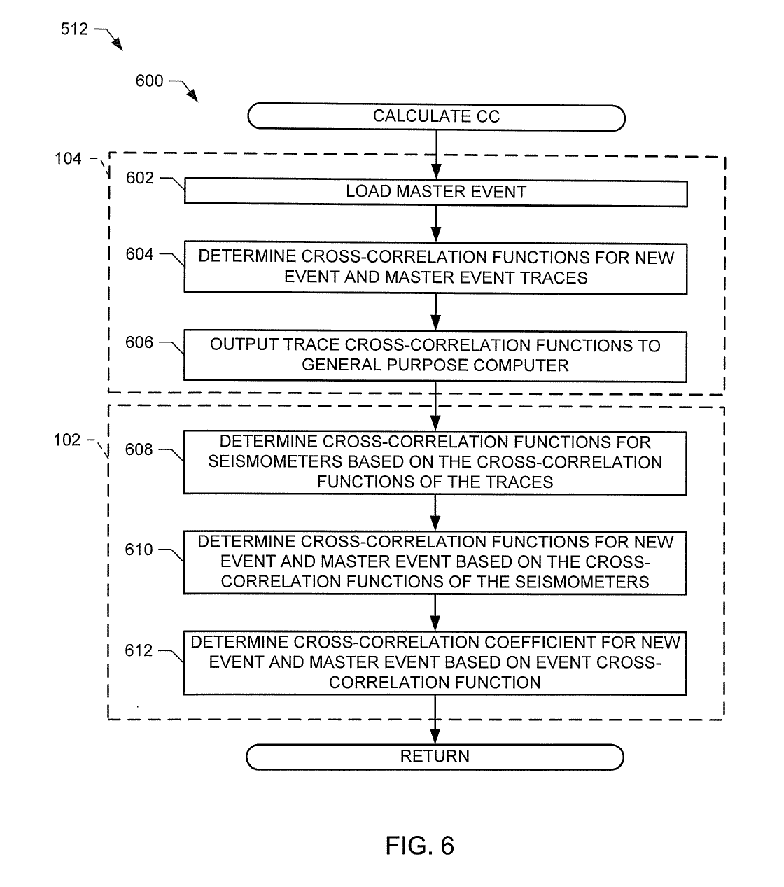

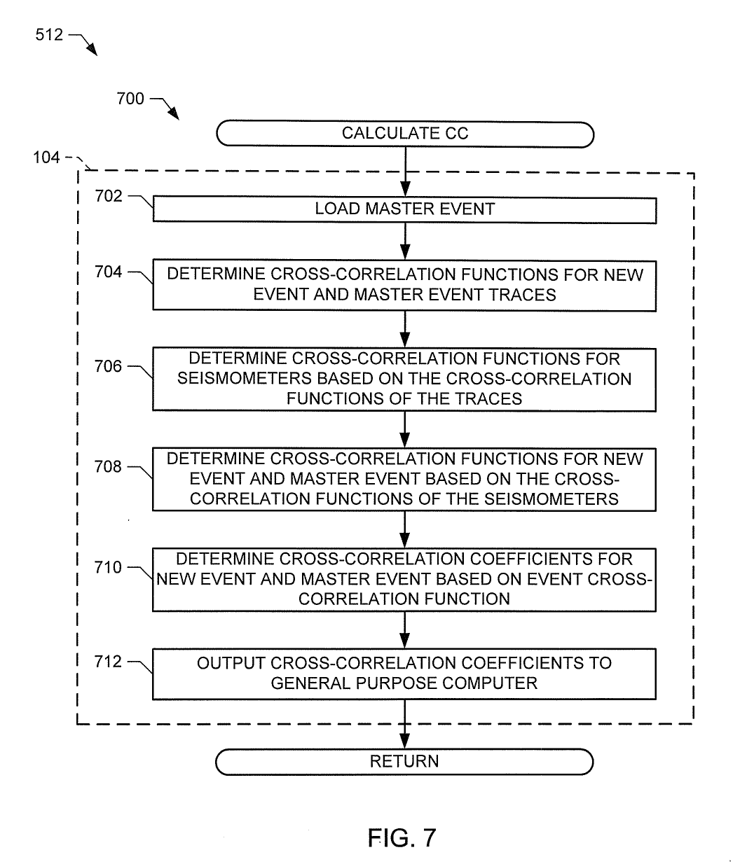

When the Cell-based processing platform 104 has received the master events, the example method 500 begins a loop of blocks 510, 512, and 514 to determine a cross-correlation between the new event and each of the master events in the memory of the Cell-based processing platform 104. The loop begins at block 510 by selecting a master event. The method 500 then determines an event cross-correlation coefficient between the new event and the selected master event (block 512). Block 512 is computationally expensive and may be implemented using one of the example methods described below with reference to FIGS. 6 and 7. After determining the cross-correlation coefficient (block 512), the loop iterates or ends at block 514. Thus, blocks 510-514 determine a cross-correlation coefficient between the new event and each of the master events.

The general purpose computer 102 then finds the master event that has the highest cross-correlation coefficient with respect to the new event (block 516). The general purpose computer 102 determines whether the highest cross-correlation coefficient is greater than a threshold (block 518). If the cross-correlation coefficient is higher than the threshold (block 518), the general purpose computer 102 determines that the new event is a doublet of the master event corresponding to the cross-correlation coefficient and adds the new event to the multiplet of the master event if appropriate (e.g., if the master event already has one or more doublets) (block 520). The general purpose computer 102 then determines whether the signal-to-noise ratio (SNR) of the new event is higher than the SNR of the master event (block 522). If the SNR of the new event is higher (block 522), the new event becomes the master event and the previous master event is no longer the master event (block 524).

If the highest cross-correlation coefficient is less than the lower threshold (block 518), the general purpose computer 102 assigns the new event as a new master event that is not (yet) a doublet of any previously-processed events (block 526). After determining that the new event SNR is not higher than the master SNR (block 522), making the new event the master event (block 524), or assigning the new event as a new master event (block 526), the general purpose computer 102 stores the master event(s) and/or the new event (e.g., in the multiplet library 304 and/or in the master event(s) 318) (block 528). The example method 500 may then iterate to monitor and process additional seismic data (blocks 502-528) or end.

FIG. 6 is a flowchart illustrating an example method 600 that may be used to implement block 512 of FIG. 5 to determine a cross-correlation coefficient between a new event and a master event. The execution of the example method 600 of FIG. 6 is split between the general purpose computer 102 and the Cell-based processor platform 104 of FIG. 3. The example method 600 enters from block 510 of FIG. 5. The Cell-based processor platform 104 loads a master event (e.g., the master event selected in block 510 of FIG. 5 for the current iteration of the loop of blocks 510-514) (block 602). The Cell-based processor platform 104 (e.g., via the trace CCF determiner 310 of FIG. 3) determines CCFs for the new event and the selected master event (e.g., using Equation 1) (block 604). Block 604 is computationally expensive and some example execution efficiencies to increase the processing time of block 604 are described below.

In the example method 600, the Cell-based processor platform 104 outputs the determined trace CCFs to the general purpose computer 102 (block 606). The general purpose computer 102 determines seismometer CCFs based on the trace CCFs (block 608). The general purpose computer 102 then determines an event CCF for the new event and the selected master event based on the seismometer CCFs (block 610). Based on the event CCF, the general purpose computer 102 determines the cross-correlation coefficient between the new event and the selected master event (block 612).

The example method 600 of FIG. 6 may use a modified Cell-based processing platform from the example Cell-based processing platform 104 illustrated in FIG. 3. Specifically, the example seismometer CCF determiner 312, the example event CCF determiner 314, and the example event CC determiner 316 may be omitted and/or moved into the general purpose computer 102. The example general purpose computer 102 and the example Cell-based processing platform 104 may implement blocks 604, 608, 610, and 612 in any desired combination.

FIG. 7 is a flowchart illustrating another example method 700 that may be used to implement the example block 512 of FIG. 5. In contrast to the example method 600 of FIG. 6, the example method 700 is performed by the Cell-based processing platform 104, which outputs the event cross-correlation coefficients to the general purpose computer 102. The example method 700 begins by loading a master event (e.g., the master event selected in block 512 of FIG. 5) (block 702).

The Cell-based processing platform 104 (e.g., via the trace CCF determiner 310) determines the trace CCFs for the new event and the selected master event (block 704). The example seismometer CCF determiner 312 then determines the seismometer CCFs based on the trace CCFs (block 706). Based on the seismometer CCFs, the example event CCF determiner 314 determines the event CCF for the new event and the selected master event (block 708). The event CC determiner 716 determines the cross-correlation coefficient from the event CCF (block 710). While the example blocks 702-710 may each have results that are identical to the respective blocks 602, 604, 608, 610, and 612 of FIG. 6, the example blocks 702-710 are implemented differently because they are executed in the Cell-based processing platform 104. In particular, the example blocks 702-710 may have higher performance than the blocks 602, 604, 608, 610, and 612 due to the delegation of additional computations (e.g., blocks 706-710) to the Cell-based processing platform 104. However, delegation of additional computations to the Cell-based processing platform 104 may not always increase performance. For example, data transmission overhead or highly-serialized instructions may cause delegation of additional instructions to reduce performance.

In some examples, the trace CCF determiner 310 determines the trace CCFs in the frequency domain using, for example, the Fastest Fourier Transform in the West (FFTW) library, which includes code designed for the Cell processor using all available SPEs 204-218. Using the FFTW, the trace CCF determiner 310 calculates a trace CCF between traces having 200 samples about 33 times faster than a trace CCF determiner running on a Windows® PC using an Intel Xeon 5150 processor running at 2.66 GHz. However, the example trace CCF determiner 310 using the FFTW library has little room for further improvement of efficiency. Thus, in some other examples, the trace CCF determiner 310 determines the trace CCFs in the time domain. Although performance of a trace CCF determination on one SPE was about two times slower than performance in the frequency domain with FFTW, the trace CCF determiner 310 may parallelize the multiple trace CCF determination in the time domain using the SPEs 204-218 and SIMD instructions.

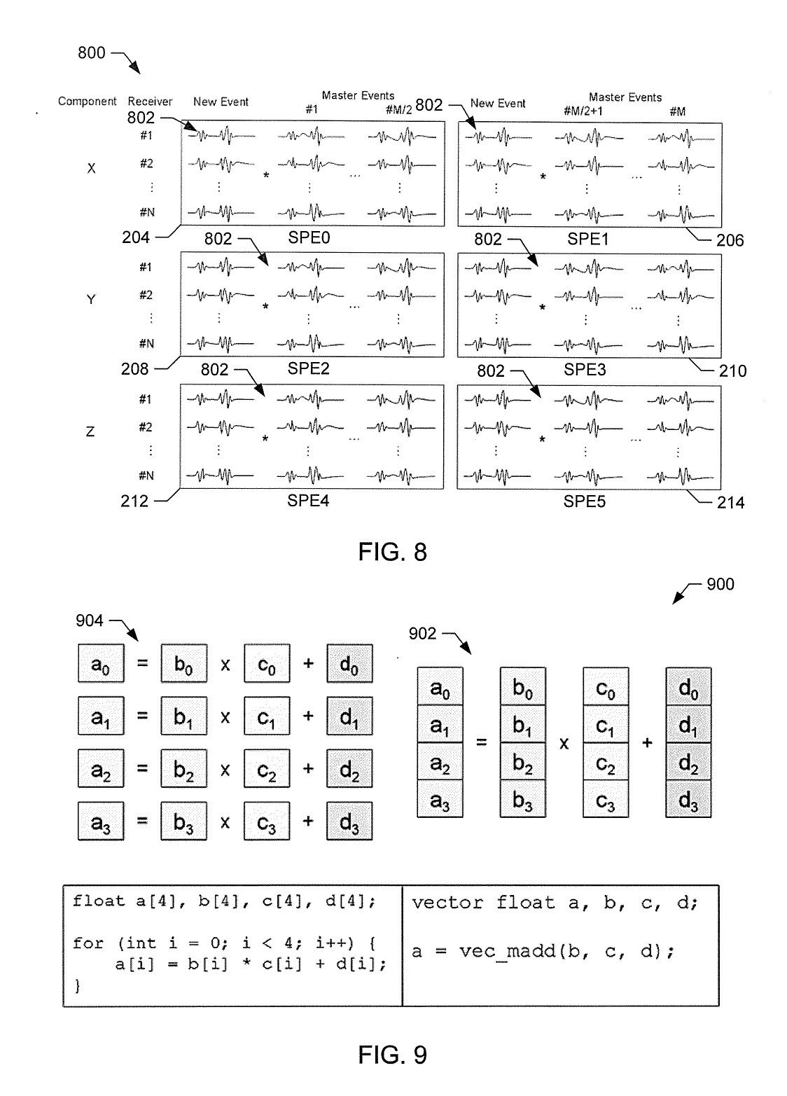

As the example trace CCFs determiner 310 determines the trace CCFs from the traces recorded by a network of seismometers 108, each having three-component traces, the trace CCF determiner 310 performs 3×N×M trace CCF calculations, where N is the number of receivers and M is the number of master events that have been identified. FIG. 8 depicts an example parallelization 800 of trace CCF calculations 802 to a plurality of SPEs 204-214 in the Cell processor 200 of FIG. 2. As illustrated in FIG. 8, each SPE 204-214 performs a trace CCF determination for one of the component traces of the new event with one-half of the master events. In other words, the trace CCF determiner 310 uses two of the SPEs 204-214 per component trace CCF. For example, the SPE0 204 and the SPE1 206 each determine a trace CCF for the X component traces of the seismometers 108, but the SPE0 204 determines the trace CCF for the X component traces of the new event and the X component traces of each the master events numbered #1-#M/2, and the SPE1 206 determines the trace CCF for the X component traces of the new event and the X component traces of each the master events numbered #(M/2)+1-#M, where M is the total number of master events. The SPEs 208 and 210, and the SPEs 212 and 214 perform the same division of trace CCF determinations as the SPEs 204 and 206 with the Y and Z component traces, respectively.

FIG. 9 depicts an example operation 900 using a single-instruction-multiple-data instruction 902 (e.g., an add-multiple instruction) and corresponding scalar instructions 904. The example scalar instruction 904 used by, for example, the general purpose computer 102, performs four identical operations that require at least four clock cycles to complete. In contrast, six of the example SPEs 204-214 of FIG. 2 utilize the example SIMD instruction 902 to simultaneously perform the identical operations on the identical data as the scalar instruction 904. With SIMD, a single instruction performs four arithmetic operations. Thus, one can parallelize 24 trace CCF determination tasks using six of the SPEs 204-214. Accordingly, the SPEs 204-214 perform the data manipulations in fewer clock cycles than would be required to execute the scalar instructions 902.

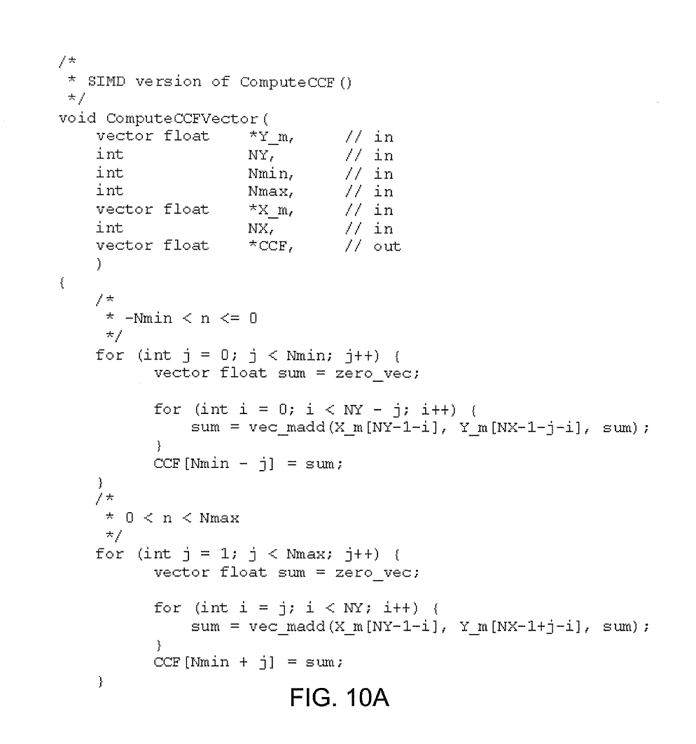

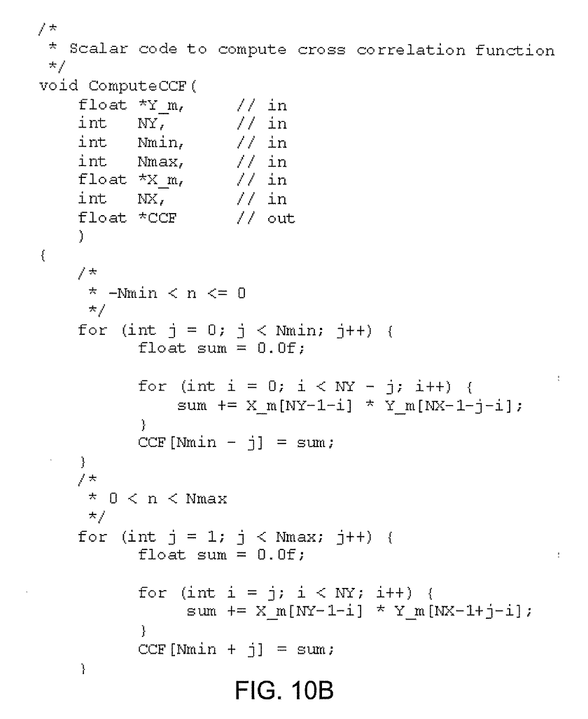

FIGS. 10A and 10B illustrate example SIMD code 1000 compared to the scalar code 1002 to perform the same CCF determination. The example trace CCF determination performed on a PS3 runs about 69 times faster than a known RTMI application run on a Windows platform.

The example trace CCF determination is further improved for execution on the SPEs 204-214 by using loop unrolling (e.g., reducing instruction overhead at the expense of program size) to increase register usage, by ordering instructions to fill pipelines with dual-issue instructions (e.g., issuing different instructions to different groups of processing units), by hiding DMA memory transfer latency with double buffering, and/or by reducing conditional branching.

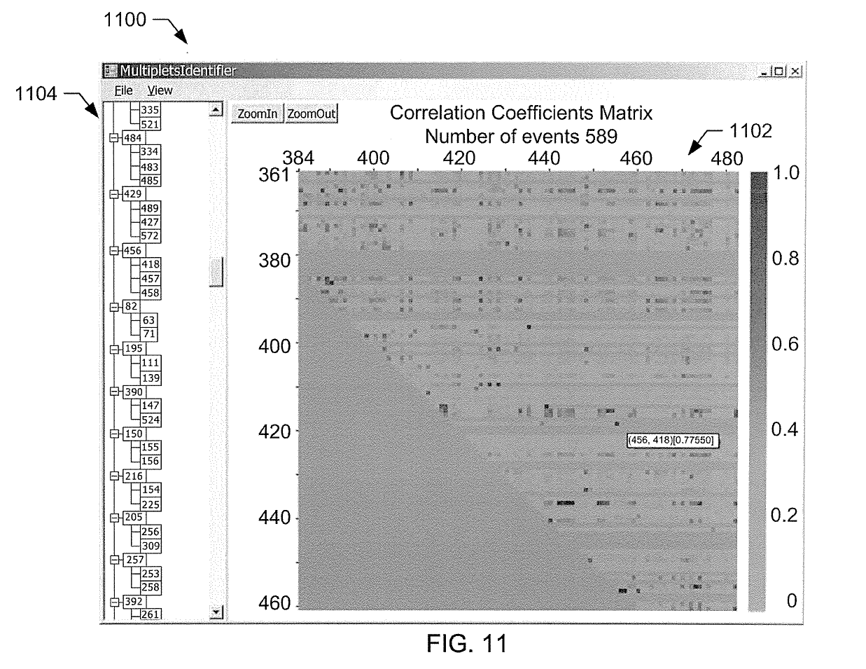

FIG. 11 illustrates example cross-correlation coefficients 1100 from an RTMI operation with an example microseismic dataset for hydraulic fracturing. The traces used to detect events were recorded by 7 three-component seismometers installed at horizontal portions of a borehole. Events used for identifying multiplets were detected and located by a three-dimensional continuous microseismic mapping method, which is described in U.S. patent application Ser. No. 12/420,061. A map 1102 illustrates the event CCs for each of the event pairs. Since event CCs are measured between a master event and a newly-detected event, event CCs are not measured for all possible pairs of events. A listing 1104 of identified multiplets shows the event IDs of master events and corresponding slave events that belong to the master event.

FIG. 12 illustrates an example comparison of master waveforms 1202 and slave waveforms 1204 between the event pairs comprising a doublet. The illustrated waveforms 1202 and 1204 are X component traces for each of the seven seismometers 108 used to generate the example cross-correlation coefficients of FIG. 11. As illustrated in FIG. 12, the master waveforms 1202 and the slave waveforms 1204 are highly similar.

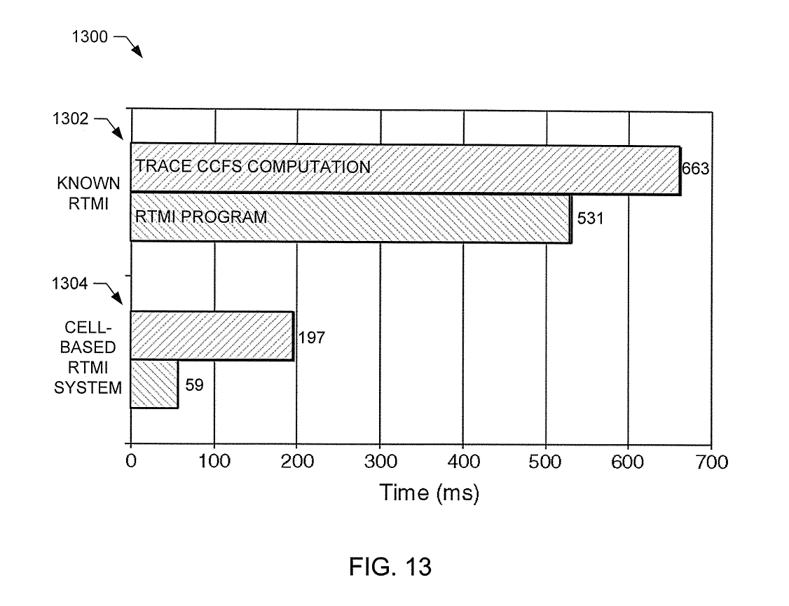

FIG. 13 is a graph 1300 illustrating the execution times 1302 of a known RTMI program run on a general purpose computer using Windows® implementing the execution times 1304 of the example RTMI system 100 of FIG. 1 and the example methods 500 and 600 of respective FIGS. 5 and 6. The execution times 1304 of the RTMI system 300 indicates the elapsed time for trace CCF determination as measured on the general purpose computer 102. Although the trace CCF determination on the RTMI system 300 showed a performance improvement of 69 times, only a 9 times improvement was measured on the general purpose computer 102. Thus, the overall performance improvement between the known RTMI program and the example RTMI system 100 was 3.4 times. The difference between the performance improvements results from the overhead created by sending and receiving data between the general purpose computer 102 and the Cell-based processing platform 104 was about 4 times as large as the trace CCF determination performed by the Cell-based processing platform 104.

Accordingly, the example RTMI system 300 includes the master events 318 to reduce data transfer to and from the Cell-based processing platform. When the example multiplet determiner 308 stores or updates a master event in the multiplet library 304, the multiplet library 304 also transmits the master event to the master events 318 in the Cell-based processing platform 104. The master events 318 may be stored, for example, in a RAM of the Cell-based processing platform 104 to increase execution speed. By storing the master events 318 in the memory of the Cell-based processing platform 104, data input and, thus, overhead to the Cell-based processing platform 104 is reduced. Additionally, data output from the Cell-based processing platform 104 may also be reduced by performing the event CC determination in the PPE 202 on the Cell-based processing platform 104. Thus, instead of outputting a relatively large function to the general purpose computer 102, the Cell-based processing platform 104 may instead determine the event CC from the event CCF and output a smaller cross-correlation coefficient.

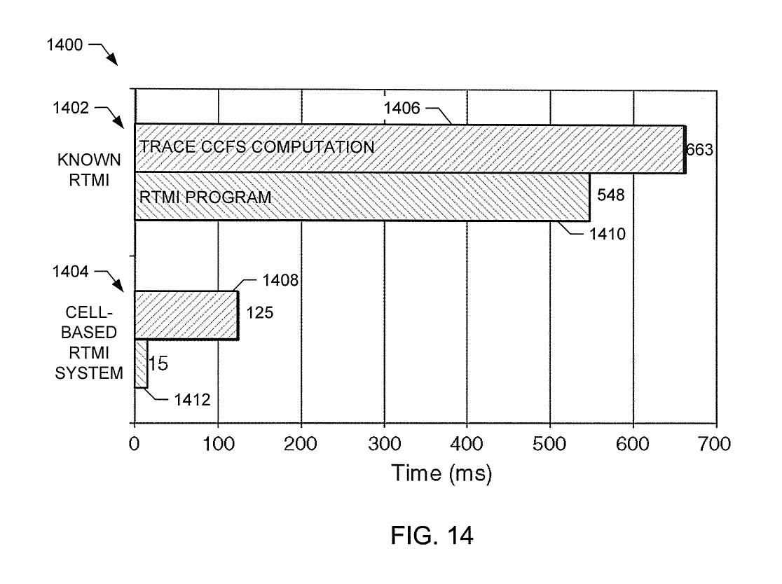

FIG. 14 is a graph 1400 illustrating the execution times 1402 of a known RTMI program run on a general purpose computer using Windows® and the execution times 1404 of the example RTMI system 300 of FIG. 3 and the example methods 500 and 700 of respective FIGS. 5 and 7. The top bars 1406 and 1408 of the execution times 1402 and 1404 show the respective times required to process the 100th event with a test dataset having eight receivers and a 0.5-ms sampling rate for the known RTMI program and the example RTMI system 300. The example RTMI system 300 has a performance improvement of about 5.3 times that of the known RTMI program. The bottom bars 1410 and 1412 of the execution times 1402 and 1404 show the respective elapsed times of the event cross-correlation determinations for the known RTMI program and the example RTMI system 300, including data transfer time. As shown in FIG. 14, the example RTMI system 300 has a performance improvement for the event CC determination of about 36 times that of the known RTMI program even with the data transfer overhead.

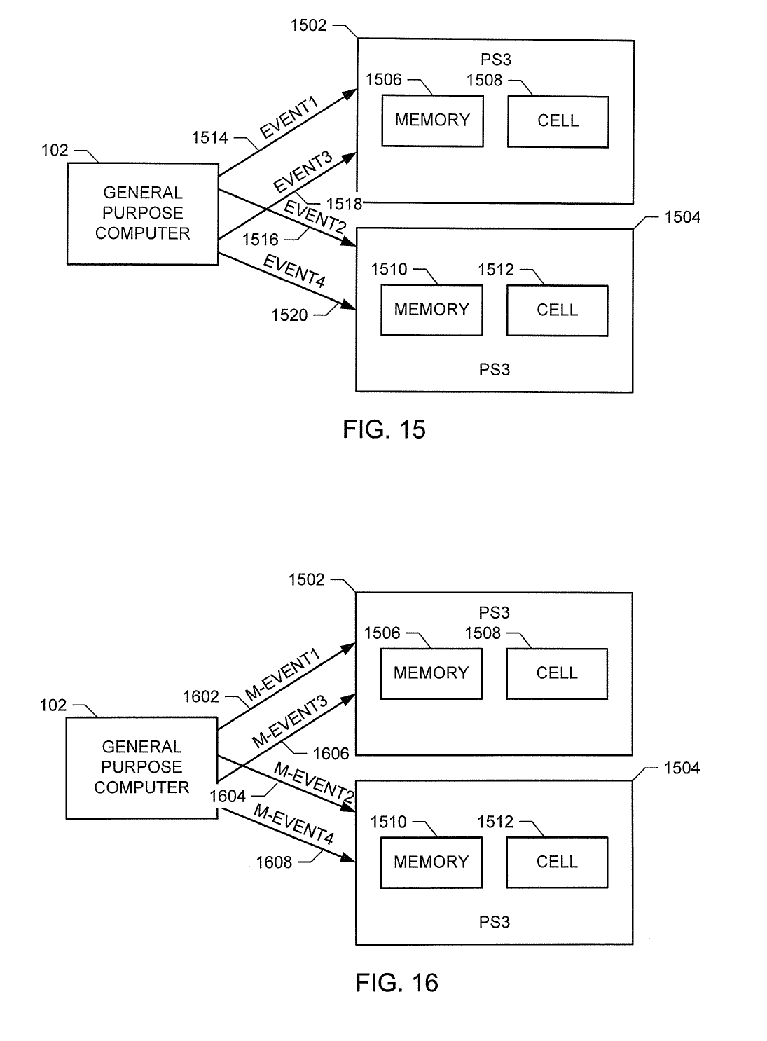

The example RTMI system 300 of FIG. 3 can process up to 2,100 events in real time when the event rate is as high as every 3 seconds. However, keeping the master events in memory can cause the memory of current Cell-based processing platforms to fill. For example, the PS3 has a relatively low amount of RAM and can hold up to 5,000 master events in its main memory. However, these restrictions on the PS3 platform may be overcome by using multiple PS3 platforms that are coordinated by a general purpose computer. FIG. 15 illustrates an example oilfield data processing system 1500 that includes a general purpose computer 102 and two Cell-based processing platforms 1502 and 1504 (e.g., PS3s). The first PS3 1502 includes a first Cell processor 1506 and a first memory 1508, and the second PS3 1504 includes a second Cell processor 1510 and a second memory 1512.

In general, the PS3s 1502 and 1504 function similar or identical to the example Cell-based processing platform 104 of FIG. 3. The general purpose computer provides all master events to both of the PS3s 1502 and 1504. However, the general purpose computer 102 divides the delivery of new events between the PS3s 1502 and 1504. For example, a first new event 1516 that is detected by the general purpose computer 102 is sent to the first PS3 1502, where it is processed and the event CC is returned to the general purpose computer. The general purpose computer 102 sends a second new event 1518 to the second PS3 1504, and alternates the subsequent new events 1520 and 1522 between the PS3s 1502 and 1504. In some other examples, only the first PS3 1502 is used for processing new events until the processing time for new events increases above the time to receive a new event, at which time the second PS3 1504 may be utilized. Thus, the PS3s 1502 and 1504 have more time between new events for processing, and more events may be processed before the processing time for each new event is longer than the time to receive two new events. Of course, the example RTMI system 1500 may be extended to include additional PS3s, thereby increasing the allowable processing time per new event.

FIG. 16 illustrates another example oilfield data processing system 1600 that includes a general purpose computer 102 and two Cell-based processing platforms 1502 and 1504 (e.g., PS3s). The example RTMI system 1600 has a similar or identical structure as the example RTMI system 1500 of FIG. 15 and includes the general purpose computer 102 and the PS3s 1502 and 1504. Instead of providing all master events to all of the PS3s 1502 and 1504 as in the example RTMI system 1500 of FIG. 15, the example general purpose computer 102 of FIG. 16 provides all new events to each of the PS3s 1502 and 1504 and divides the master events between the PS3s 1502 and 1504. Thus, the general purpose computer 102 may provide a first master event 1602 to the first PS3 1502 and provide a second master event 1604 to the second PS3 1504. The general purpose computer 102 then continues by alternating additional master events 1606 and 1608 between the PS3s 1502 and 1504.

In some other examples, only the first PS3 1502 is used for processing new events and receives all master events 1602 and 1604 until the processing time for new events increases above the time to receive a new event. At that time, the second PS3 1504 is utilized and the general purpose computer 102 provides all further master events 1606 and 1608 to the second PS3 1504 while providing all new events to both PS3s 1502 and 1504.

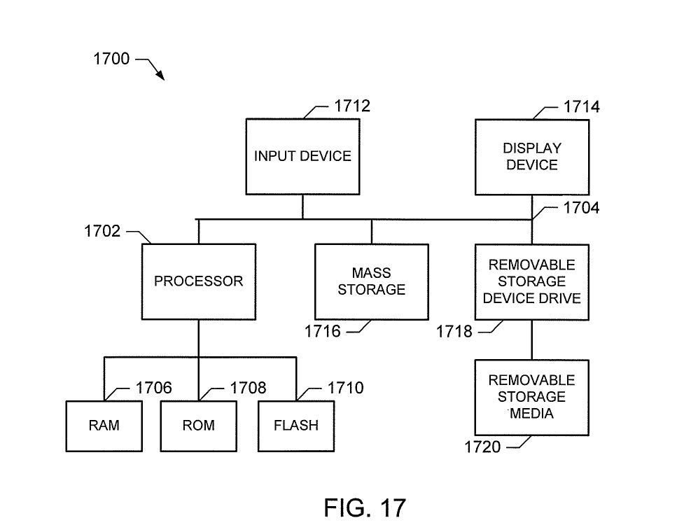

FIG. 17 is a block diagram of an example computing system 1700 that may be used to implement the example systems and methods described herein. For example, the computing system 1700 may be used to implement the above-described general purpose computer 102. The example computing system 1700 may be, for example, a conventional desktop personal computer, a notebook computer, a workstation or any other computing device. A processor 1702 may be any type of processing unit, such as a microprocessor from the Intel® Pentium® family of microprocessors, the Intel® Itanium® family of microprocessors, and/or the Intel XScale® family of processors. Memories 1706, 1708 and 1710 that are coupled to the processor 1702 may be any suitable memory devices and may be sized to fit the storage demands of the system 1700. In particular, the flash memory 1710 may be a non-volatile memory that is accessed and erased on a block-by-block basis.

An input device 1712 may be implemented using a keyboard, a mouse, a touch screen, a track pad or any other device that enables a user to provide information to the processor 1702. The input device 1712 may additionally or alternatively include a seismometer interface to receive input from the one or more seismometers 108 of FIG. 1.

A display device 1714 may be, for example, a liquid crystal display (LCD) monitor, a cathode ray tube (CRT) monitor or any other suitable device that acts as an interface between the processor 1702 and a user. The display device 1714 as pictured in FIG. 17 includes any additional hardware required to interface a display screen to the processor 1702.

A mass storage device 1716 may be, for example, a conventional hard drive or any other magnetic or optical media that is readable by the processor 1702.

A removable storage device drive 1718 may, for example, be an optical drive, such as a compact disk-recordable (CD-R) drive, a compact disk-rewritable (CD-RW) drive, a digital versatile disk (DVD) drive or any other optical drive. It may alternatively be, for example, a magnetic media drive. A removable storage media 1720 is complimentary to the removable storage device drive 1718, inasmuch as the media 1720 is selected to operate with the drive 1718. For example, if the removable storage device drive 1718 is an optical drive, the removable storage media 1720 may be a CD-R disk, a CD-RW disk, a DVD disk or any other suitable optical disk. On the other hand, if the removable storage device drive 1718 is a magnetic media device, the removable storage media 1720 may be, for example, a diskette or any other suitable magnetic storage media.

Although example methods, apparatus and articles of manufacture have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A system for processing oilfield data, comprising:
a first computer comprising a first processor and first memory; and
a second computer coupled to the first computer, the second computer comprising a second processor and a second memory, wherein the second processor has a faster processing speed than the first processor, and wherein the first memory stores an amount of oilfield data larger than the second memory and instructions for:
receiving the oilfield data at the first computer;
processing the oilfield data at the first computer to generate second data;
transmitting at least a portion of the second data to the second computer for processing performed by the second computer, wherein the processing performed by the second computer has a higher computational load than the processing performed by the first computer; and
receiving data resulting from the processing by the second computer.

2. A system as defined in claim 1, wherein the second processor comprises a Cell Broadband Engine processor.

3. A system as defined in claim 1, wherein the second memory stores a second program having instructions for:
determining a first trace cross-correlation function based on corresponding component data traces of an event and a first master event from the second data transmitted by the first computer;
determining a first seismometer cross-correlation function based on the first trace cross-correlation function and a second trace cross-correlation function;
determining an event cross-correlation function based on the first seismometer cross-correlation function and a second seismometer cross-correlation function; and
determining an event cross-correlation coefficient based on an upper value of the event cross-correlation function.

4. A system as defined in claim 1, wherein the first and second computers are communicatively coupled via a local area network connection.

5. A system as defined in claim 1, wherein the processing performed by the second processor comprises using at least one of parallelization or single-instruction-multiple-data instructions.

6. A system as defined in claim 1, wherein the second computer is one of a plurality of computers having respective processors and memories, wherein the respective processors have faster processing speeds than the first processor, and wherein the first memory stores a program larger than the respective memories of the plurality of computers and includes instructions for:
transmitting respective portions of the second data to the plurality of computers, wherein the portions of the second data are associated with processing performed by the plurality of computers having higher respective computational loads than the processing performed by the first computer; and
receiving data resulting from the respective processing from the plurality of computers.

7. A system as defined in claim 1, wherein the oilfield data comprises microseismic data, and the program has instructions for detecting an event based on the microseismic data and transmitting at least some of the microseismic data from the first computer to the second computer, and wherein the second memory stores a program having instructions for determining whether the event belongs to a multiplet of a first master event by comparing the microseismic data to data associated with the first master event.

8. A method to process oilfield data, comprising:
receiving oilfield data at a first computer having a first processor;
processing the oilfield data to generate second data representative of the oilfield data, wherein a first portion of the processing is performed by the first computer and a second portion of the processing is performed by a second computer having a higher processing speed and a smaller memory than the first computer, and wherein the first and second portions have different computational loads; and
transmitting data resulting from the second portion of the processing from the second computer to the first computer.

9. A method as defined in claim 8, wherein the second portion of the processing comprises at least one of parallelizing execution of instructions using a plurality of processing cores or issuing single-instruction-multiple-data instructions.

10. A method as defined in claim 8, wherein the processing comprises generating third data from the oilfield data and transmitting at least a portion of the third data to a third computer having a higher processing speed and a smaller memory than the first computer.

11. A method as defined in claim 10, wherein the second portion of the processing comprises storing at least a portion of the third data in a register corresponding to at least one of a plurality of processing cores using direct memory access.

12. A method as defined in claim 8, further comprising storing at least a portion of the resulting data from the second portion of the processing at the second computer to reduce a data transfer time.

13. A method as defined in claim 8, further comprising performing a plurality of portions of the processing using a plurality of computers including the second computer, the plurality of computers having higher respective processing speeds and smaller respective memories than the first computer, and wherein the plurality of portions have different respective computational loads than the first portion.

14. An article of manufacture comprising machine readable instructions which, when executed, cause a machine to:
receive oilfield data at a first computer having a first processor;
process the oilfield data to generate second data representative of the oilfield data, wherein a first portion of the processing is performed by the first computer; and
receive data resulting from a second portion of the processing from a second computer, wherein the second portion of the processing is performed by the second computer having a higher processing speed and a smaller memory than the first computer, and wherein the first and second portions have different computational loads.

15. An article of manufacture as defined in claim 14, wherein the second portion of the processing comprises at least one of parallelizing execution of instructions using a plurality of processing cores or issuing single-instruction-multiple-data instructions.

16. An article of manufacture as defined in claim 14, wherein the processing comprises generating third data from the oilfield data and transmitting at least a portion of the third data to the second computer.

17. An article of manufacture as defined in claim 16, wherein the second portion of the processing comprises storing at least a portion of the third data in a register corresponding to at least one of a plurality of processing cores using direct memory access.

18. An article of manufacture as defined in claim 14, wherein the instructions further cause the machine to store at least a portion of the resulting data from the second portion of the processing at the second computer to reduce a data transfer time.

19. An article of manufacture as defined in claim 14, wherein the instructions further cause the machine to perform a plurality of portions of the processing using a plurality of computers including the second computer, the plurality of computers having higher respective processing speeds and smaller respective memories than the first computer, and wherein the plurality of portions have different respective computational loads than the first portion.

20. An article of manufacture as defined in claim 19, wherein the instructions further cause the machine to receive respective resulting data from the plurality of computers and to combine the received resulting data with the first resulting data.
